(19) United States
(12) Patent Application Publication
(10) Pub. No.: US 2011/0073529 A1
(43) Pub. Date: Mar. 31, 2011

(54) SCRAP METAL RECOVERY SYSTEM AND METHOD

(75) Inventors: Michael Dean Sprouse, Kemah, TX (US); Tracy Layne Bolware, Houston, TX (US)

(73) Assignee: ALTRA INDUSTRIES, LLC, Houston, TX (US)

(21) Appl. No.: 12/569,091

(22) Filed: Sep. 29, 2009

(51) Int. Cl. B03C 1/30; B03C 1/16; B03C 1/22; B03C 1/00; B03C 1/14; B07B 15/00; B07B 1/00

(52) U.S. Cl. 209/3; 209/38; 209/214; 209/225

(57) ABSTRACT

A system and method for recovering ferrous material from the boiler grit of burnt tires used to create electricity or heat at industrial locations. The system includes a magnetic separator for attracting the ferrous material out of the boiler grit, and a series of conveyors for transporting the ferrous and non-ferrous materials away from the system.

### FIELD

Embodiments of the disclosure may generally relate to the separation of usable metals from boiler grit.

### BACKGROUND

It is not uncommon for industrial factories, plants, and mills to burn combustible materials onsite to either create electricity for the factory/plant or to supply heat for water and ambient temperature regulation. Typical combustible materials burned onsite at an industrial location may include wood, coal, oil, refuse, etc., but generally will be the cheapest and most readily-available burnable material. Recently, industrial locations have been using pre-shredded automotive tires as a source of combustible materials, since tires can be obtained quite inexpensively, and burning tires serves to reduce the amount of landfill intake.

Tires today, however, are manufactured to include numerous steel belts (i.e., “radials”), which are used to reinforce the area under the tread, to provide puncture resistance, and to help the read surface remain planar so that it makes the best contact with the road. The combustion process at an industrial location rarely reaches temperatures sufficient to melt or incinerate the radials. Therefore, after the burning process, charred steel radials will generally remain in the boiler grit, or burnt residue, along with a substantial amount of dirt and rock. Having no apparent value of use, the boiler grit, including the charred radials, is then typically shipped at a cost by the industrial location to a local landfill for disposal, or on site.

As can be readily appreciated, however, the charred steel radials may have potential value in the scrap metal industry. If properly recovered from the boiler grit and cleaned for recycling purposes, the charred radials may be sold as valuable scrap metal. Furthermore, because of the burning process, the charred radials are generally free from any tire residue which steel mills or scrap metal yards often refuse to accept.

What is needed, therefore, is an efficient system and method of removing charred steel radials from the boiler grit resulting from burning tires at industrial locations.

### SUMMARY

Embodiments of the disclosure may provide a system for removing ferrous materials from furnace boiler grit. The system may include a hopper configured to receive the boiler grit derived from burning tires, and having a vibratory feeder coupled thereto, wherein the vibratory feeder has a conveyor configured to transport the boiler grit away from the hopper, a grating coupled to the hopper and having a plurality of slats configured to prevent the admission of large objects into the hopper, wherein the grating is disposed at an incline relative to the hopper, such that the large objects fall off the grating, and a magnetic separator having a magnet configured to attract ferrous materials in the boiler grit, thereby separating the ferrous materials from a remaining non-ferrous residue. The system may also include a residue collection module configured to collect the remaining non-ferrous residue, a non-ferrous material conveyor configured to transport the remaining non-ferrous residue away from the system, a metal collection module configured to collect the ferrous material, and a ferrous material conveyor communicably coupled to the metal collection module and configured to transport the ferrous material away from the system.

Embodiments of the disclosure may further provide a method of removing ferrous materials from boiler grit. The method may include receiving the boiler grit in a hopper, wherein the boiler grit includes charred steel radials derived from burning tires, transporting the boiler grit away from the hopper toward a magnetic separator via a conveyor, and separating the charred steel radials from the boiler grit using the magnetic separator, thereby leaving a non-ferrous residue. The method may also include collecting the non-ferrous residue in a residue collection module located adjacent to the conveyor, conveying the non-ferrous residue away from the system via a non-ferrous material conveyor communicably coupled to the residue collection module, collecting the ferrous materials in a metal collection module located adjacent to the magnetic separator, and conveying the ferrous material away from the system with a ferrous material conveyor communicably coupled to the metal collection module.

Embodiments of the disclosure may further provide a system for removing ferrous materials from a boiler grit having ferrous and non-ferrous materials. The exemplary system may include a hopper configured to receive the boiler grit, and having a vibratory feeder coupled thereto, wherein the vibratory feeder has a conveyor capable of transporting the boiler grit away from the hopper, a magnetic separator having a magnet designed to attract the ferrous materials in the boiler grit, thereby separating the ferrous materials from the non-ferrous materials and leaving a non-ferrous residue, a first material transportation vehicle located adjacent to the conveyor and configured to collect the non-ferrous residue for transport away from the system, and a second material transportation vehicle located adjacent to the magnetic separator and configured to collect the ferrous material for transport away from the system.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates an exemplary system for recovery of scrap metal from burnt tires, according to one or more embodiments of the disclosure.

FIG. 2 illustrates a portion of FIG. 1 detailing an exemplary magnet separator as a crossbelt magnetic separator, according to one or more embodiments of the disclosure.

FIG. 3 illustrates a portion of FIG. 1 detailing the exemplary magnet separator as a rotary drum separator, according to one or more embodiments of the disclosure.

FIG. 4A illustrates an exemplary system for recovery of scrap metal from burnt tires, according to one or more embodiments of the disclosure.

FIG. 4B illustrates a perspective view of a portion of FIG. 4A showing the magnet separator in conjunction with the material conveyor.

FIG. 5 illustrates a pre-processing procedure configured to remove a substantial amount of non-ferrous material from the boiler grit.

FIG. 6 illustrates an exemplary of removing and cleaning ferrous material from a boiler grit, according to one or more embodiments of the disclosure.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure, however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, ° the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope.

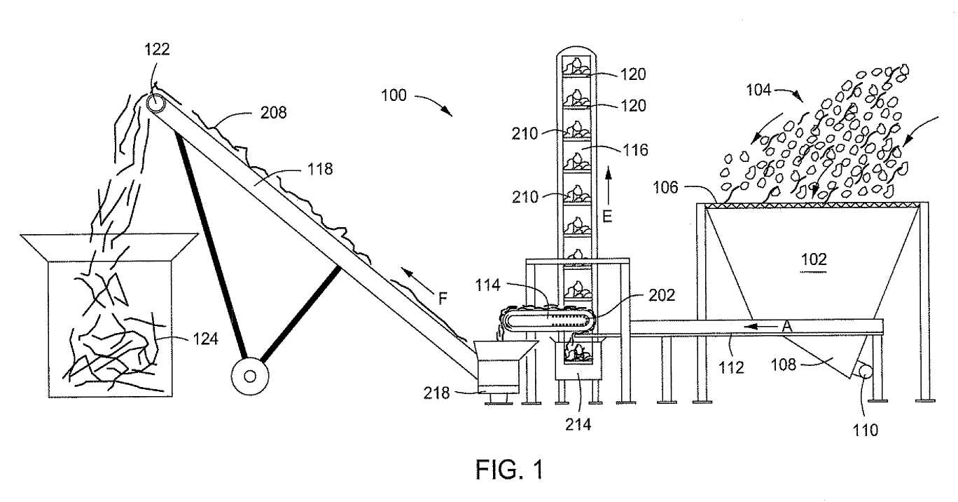

FIG. 1 illustrates an exemplary scrap metal recovery system 100. The system 100 may include a hopper 102 configured to receive a material, such as a boiler grit 104 for processing and cleaning. In an exemplary embodiment, boiler grit 104 may include the burnt residue acquired from a boiler or furnace of at least one industrial location (not shown), such as a factory, mill, or plant. The boiler grit 104 may include the remains of the substance that was burnt and also such impurities as dirt and rock.

Combustion chambers, such as a boiler located at industrial locations, may produce the boiler grit 104 as a result of locally burning a combustible material, such as coal or wood, to produce electricity or heat for the location. In at least one embodiment, the industrial location burns worn and/or pre-shredded automotive or industrial tires having steel radials. Thus, the boiler grit 104 from the tires may include a significant amount of recyclable ferrous material, including the charred remains of the steel radials, which may be removed and cleaned via embodiments of the system 100 herein disclosed. Moreover, because of the prior burning process, the ferrous material may be substantially clean of tire residue, which steel mills and recycling centers will typically reject.

The boiler grit 104 may be introduced to the hopper 102 via a grating 106 coupled to the hopper 102 at its top. The grating 106 may include a plurality of longitudinal slats, or otherwise crisscrossed slats, that provide an area for the boiler grit 104 to fall into the hopper 102, while preventing the admission of larger objects, such as rocks and other unwanted residue. Thus, the grating 106 may serve to filter the boiler grit 104 to remove large objects that may obstruct various moving parts used in the system 100. In at least one exemplary embodiment, the grating 106 may be disposed at an incline relative to the hopper 102, whereby larger objects may “roll” or otherwise fall off the grating 106 and onto either an adjacent receptacle (not shown) or the ground for subsequent removal or usage. In another exemplary embodiment, the grating 106 may be configured to be self-cleaning so as to prevent clogging. For example, the grating 106 may be an actuated grating designed to dispose of caught objects.

In an exemplary embodiment, the hopper 102 may include a gravity hopper or a slant hopper, as is known in the art. In at least one embodiment, the hopper 102 may include three interior sides which are each angled at about 45 degrees and one side that is substantially vertical, thereby causing the contents of the hopper 102 to funnel towards an outlet located at the bottom via gravitational forces. In another exemplary embodiment, the hopper 102 may include four interior sides which are all angled toward an outlet located at a centralized-bottom location, and configured to funnel the contents thereto.

A commercially-available vibratory feeder 108 may be coupled to the bottom of the hopper 102 at its outlet. The vibratory feeder 108 may be powered by a motor 110 and configured to vibrate the boiler grit 104 towards the bottom of the hopper 102. As follows, the vibratory feeder 108 may also serve to vibrate the boiler grit 104 in the hopper 102 so as to break up any chunks of boiler grit 104 and pre-separating the metal from the dirt and rock. Furthermore, the vibratory feeder 108 may feed the boiler grit 104 onto an adjacent conveyor 112. In at least one embodiment, the conveyor 112 may be an integral part of the vibratory feeder 108 and be designed to receive the boiler grit 104 and transport it aided by vibrational energy in the direction of arrow A. In one embodiment, the conveyor 112 may be slightly declined relative to ground so as to allow gravitational forces to contribute to the movement in direction A. In another embodiment, the conveyor 112 may include a belt-conveying system, as is known in the art, and the vibratory feeder 108 may be designed to feed the boiler grit 104 onto the conveyor 112 by means of an auger positioned in or near the lower portion of the hopper 102, for example. In this exemplary embodiment, a motor may power the conveyor 112 to transport the boiler grit 104 in the direction of arrow A.

The boiler grit 104 transported in direction A may be transported by the conveyor 112 toward a crossbelt magnetic separator 114. In an exemplary embodiment, a leveling device (not illustrated) may be employed over the conveyor 112 to “rake” the boiler grit 104 to a substantially leveled height. Raking the incoming boiler grit 104 to a level height may allow the crossbelt magnetic separator 114 to continuously receive an equal amount of boiler grit 104 thereby avoiding the clogging of the system 100. The crossbelt magnetic separator 114 may be configured to remove a substantial portion of the ferrous content from the boiler grit 104. In particular, the crossbelt magnetic separator 114 may be designed to remove the pieces of charred steel radials that once comprised the radial belts of a tire.

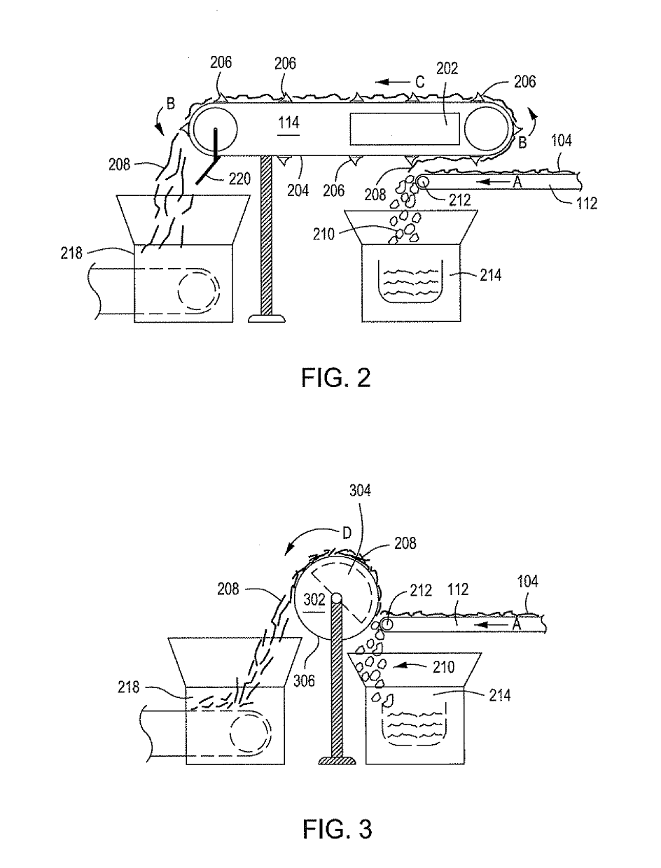

As best seen in FIG. 2, the crossbelt magnetic separator 114 may include a magnet 202 disposed between at least a portion of the length of a continuous conveyor belt 204. In an exemplary embodiment, the magnet 202 may include a permanent magnet, but may alternatively include an electromagnet having an adjustable or non-adjustable magnetic strength. The conveyor belt 204 may be made of an elastic polymer, such as high-strength rubber, and may include a plurality of cleats 206 configured to assist in discharging any ferrous material from the conveyor belt 204. In another exemplary embodiment, the conveyor belt 204 may be made of other materials suitable for magnetized applications. In one exemplary mode of operation, the conveyor belt 204 may be configured to continuously rotate in direction B, as illustrated, but may also rotate in the opposite direction for other applications, as will be discussed below.

Still referring to FIG. 2, in exemplary operation, as the boiler grit 104 moves in direction A on the conveyor 112, the magnetic field produced by the magnet 202 of the crossbelt magnetic separator 114 may attract the ferrous material 208 onto the surface of the conveyor belt 204, thereby separating it from the rock, dirt, and other non-ferrous residue 210 remaining in the boiler grit 104. At the discharge end 212 of the conveyor 112, the non-ferrous residue 210 may fall off into a residue collection module 214. The ferrous material 208, however, may be magnetically-transported in direction C and remain magnetically attracted to the surface of the conveyor belt 204 until passing outside the range of the magnetic field of the magnet 202. At the discharge end 216 of the conveyor belt 204, the ferrous material 208 may fall into a metal collection module 218, or a module for collecting metallic materials.

Thus, in at least one embodiment, the crossbelt magnetic separator 114 may be disposed co-linearly with the conveyor 112, as illustrated in FIG. 2. However, the disclosure also contemplates other configurations wherein the crossbelt magnetic separator 114 is disposed perpendicular to, or at least at an angled configuration with respect to, the conveyor 112. In this exemplary embodiment, the ferrous material 208 may be discharged either to the left or right of the conveyor 112, depending on the rotation direction of the conveyor belt 204. As can be appreciated, multiple configurations may be implemented without departing from the scope of this disclosure, and yet satisfy an equal number of applications.

In another exemplary embodiment, the conveyor belt 204 does not include cleats 206. Instead, the crossbelt magnetic separator 114 may include a scraper 220 designed to scrape the surface of the conveyor belt 204, and thereby remove any remaining ferrous materials 208 that remained attached thereto after moving out of the range of the magnetic field.

In yet another exemplary embodiment, the magnet 202 may be disposed across a substantial portion of the crossbelt magnetic separator 114 and the conveyor belt 204 may be configured to rotate in a direction opposite the direction B. Thus, the magnetic field produced by the magnet 202 may attract the ferrous material 208 onto the surface of the conveyor belt 204 and transport the ferrous material 208 on the underside of the crossbelt magnetic separator 114 in direction C. Underneath the crossbelt magnetic separator 114, the ferrous material 208 may remain magnetically attracted to the surface of the conveyor belt 204 until passing outside the range of the magnetic field of the magnet 202, at which point the ferrous material 208 may fall into the metal collection module 218, as described above. While not necessary, a scraper 220, as also described above, may be employed in this embodiment to assist in the removal of any ferrous material 208 stuck or otherwise attached to the conveyor belt 204 outside of the range of the magnetic field.

Referring now to FIG. 3, another exemplary embodiment of the system 100 is illustrated. The embodiment of FIG. 3 may be substantially similar to the embodiment disclosed with reference to FIG. 2, except that the crossbelt magnetic separator 114 as described in FIG. 2 may be omitted and replaced with a rotating drum magnet 302. As is known in the art, a rotating drum magnet 302 may include a stationary, 180 degree arc, internal magnet 304, with an outer drum surface 306 that rotates independently of the internal magnet 304 in direction D. The internal magnet 304 may include a permanent magnet, but may alternatively include an electromagnet.

Although the angular disposition of the stationary internal magnet 304 is illustrated to a specific angle, it can be appreciated that any number of angular configurations may be employed. Indeed, depending on the concentration of the ferrous material in the boiler grit 104, and its overall weight, the angular configuration of the internal magnet 304 may be altered or adjusted to suit the specific application to attract the greatest amount of material 208.

In an exemplary embodiment, a leveling device (not illustrated) may be employed over the conveyor 112 to “rake” the boiler grit 104 to a substantially leveled height. Raking the incoming boiler grit 104 to a level height may allow the crossbelt magnetic separator 114 to continuously receive an equal amount of boiler grit 104 thereby avoiding the clogging of the system 100. In exemplary operation, as the boiler grit 104 moves in direction A on the conveyor 112, the boiler grit 104 eventually encounters the magnetic field generated by the internal magnet 304, whereby the ferrous material 208 is attracted to the outer drum surface 306, separating it from the remaining rock, dirt, and other non-ferrous residue 210. At the discharge end 212 of the conveyor 112, the non-ferrous residue 210 may fall off into a residue collection module 214. The ferrous material 208, however, may be magnetically attracted to the outer drum surface 306 until the ferrous material 208 passes through the magnetic field, at which point it is discharged to the rear of the outer drum surface 306 and allowed to fall into a metal collection module 218.

Referring once more to FIG. 1, with continuing reference to FIGS. 2 and 3, the system 100 may also include a non-ferrous material conveyor 116 and a ferrous material conveyor 118. In an exemplary embodiment, the non-ferrous material conveyor 116 may be communicably coupled to the residue collection module 214 and configured to transport the non-ferrous residue 210 away from the system 100 in direction E for further processing or disposal. As illustrated, the non-ferrous material conveyor 116 may include ribs 120 designed to more easily transfer the non-ferrous material 210 up an incline and into an adjacent receptacle (not shown). As can be appreciated, however, it is not necessary that the non-ferrous material conveyor 116 be arranged at an incline of any specific angular configuration. In fact, the non-ferrous material conveyor 116 may be disposed parallel to the ground, or even at a decline, depending on the location of the adjacent receptacle.

Moreover, the non-ferrous material conveyor 116 may also be replaced with any type of receptacle or module to fit the particular application. For example, the combination of the residue collection module 214 and non-ferrous material conveyor 116 may be replaced with a material transportation vehicle, like a dump truck, for collecting the non-ferrous material 210 for shipping to another location. In at least one embodiment, once collected, the non-ferrous material 210 may be re-processed by running it through the system 100 multiple times in order to remove all traces of ferrous material 108. Also, the non-ferrous material 210 may be further processed by removing larger rocks and eventually sold as road base material.

The ferrous material conveyor 118 may be communicably coupled to the metal collection module 218. As illustrated, the ferrous material conveyor 118 may be configured to transport the ferrous material 208 up an incline and away from the system 100 in direction F. At the discharge end 122 of the ferrous material conveyor 118, the ferrous material 208 may fall into a metal collection bin 124. Similar to the non-ferrous material conveyor 116, however, it is not necessary that the ferrous material conveyor 118 be arranged at an incline of any specific angular configuration. Instead, the conveyor 118 may be disposed parallel to the ground, or even at a decline with respect to the ground, depending on the location of the collection bin 124.

Moreover, the combination of the metal collection module 218 and ferrous material conveyor 118 may be replaced with a material transportation vehicle, such as a dump truck for directly collecting the ferrous material 208 for ease of shipping to another location. In another exemplary embodiment, the metal collection bin 124 may include the bucket of a dump truck designed to receive the ferrous material 208 and facilitate easy transportation for recycling purposes. However, in each exemplary embodiment, the ferrous material 208 in the metal collection bin 124 may instead be repeatedly processed to assure a cleaner product for scrap metal yards, therefore, the material transport vehicle may include a conveying system configured to return the processed material back to the hopper 102.

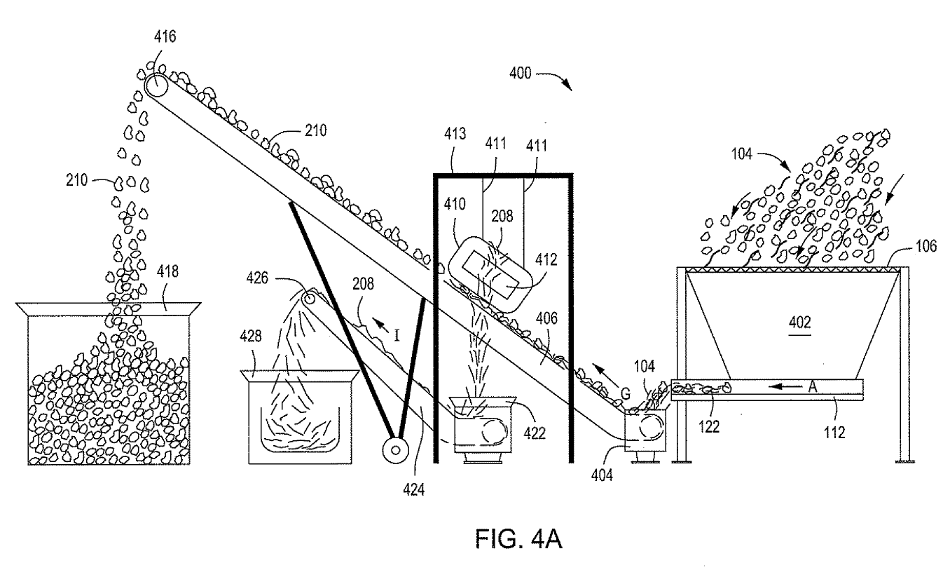

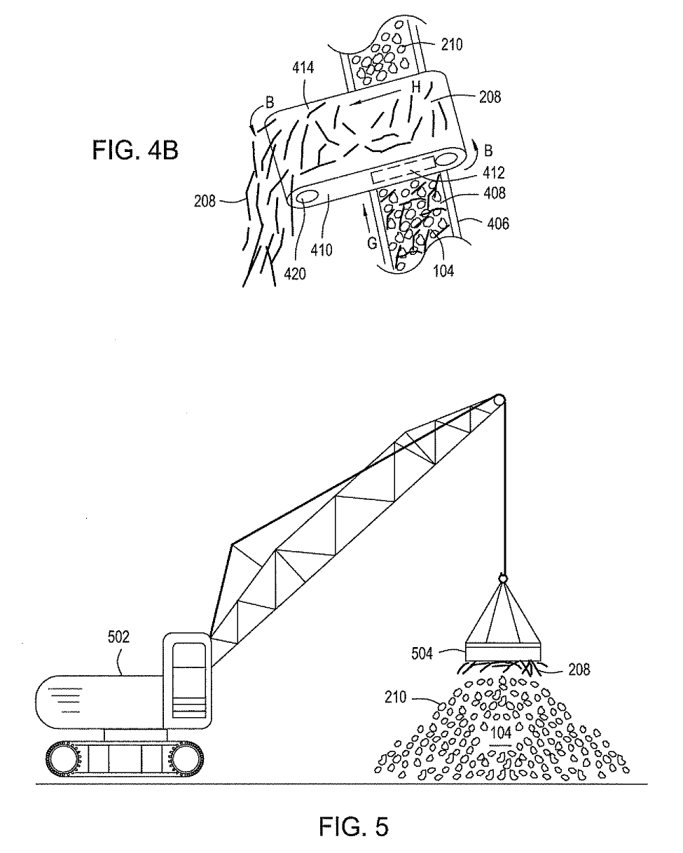

Referring now to FIGS. 4A and 4B, illustrated is an another exemplary embodiment of a system 400 according to the present disclosure. The system 400 may include substantially similar elements as the system 100 disclosed in FIG. 1. For example, the system 400 may include a hopper 402 configured to receive boiler grit 104, as described herein, for processing and cleaning. The boiler grit 104 may be introduced to the hopper 402 via a grating 106, as described above. However, in other exemplary embodiments, the system 400 may omit the grating 106.

The hopper 402, in at least one embodiment, may include a feeder, or conveyor 112, as an integral part of the hopper 402. While not illustrated herein, the hopper 402 may also include a vibratory feeder coupled to the bottom of the hopper 402 to facilitate improved transport of the boiler grit 104 via vibrational forces through the conveyor 112. In another embodiment, the conveyor 112 may include a belt-conveying system designed to feed the boiler grit 104 in the direction A.

The boiler grit 104 transported in direction A may eventually fall off the conveyor 112 and into a material collection module 404 communicably coupled to a material conveyor 406. The material conveyor 406 may include a belt-conveying system having a belt 408 configured to convey the boiler grit 104 in direction G for processing. In at least one embodiment, the belt 408 may include ribs (not shown) designed to more easily transfer the boiler grit 104 up an incline.

As the boiler grit 104 travels in direction G, it eventually passes under a crossbelt magnetic separator 410 suspended or otherwise disposed above the material conveyor 406. In at least one embodiment, as illustrated, the crossbelt magnetic separator 410 may be suspended by cables 411 attached to a support structure 413.

As best seen in FIG. 4B, the crossbelt magnetic separator 410 may be perpendicularly-disposed relative to the direction of the material conveyor 406, and configured to remove a substantial portion of the ferrous content from the boiler grit 104. In particular, the crossbelt magnetic separator 410 may include an internal magnet 412 disposed between at least a portion of the length of a continuous conveyor belt 414 and the belt 408 of the material conveyor 406. The conveyor belt 414 may be configured to continuously rotate in direction B, as illustrated, but may reverse direction for alternative applications.

In exemplary operation, as the boiler grit 104 moves in direction G on the material conveyor 406, the magnetic forces emanating from the magnet 412 of the crossbelt magnetic separator 410 may attract the ferrous material 208 onto the surface of the conveyor belt 414, thereby separating it from the rock, dirt, and other non-ferrous residue 210 remaining in the boiler grit 104. At the discharge end 416 of the material conveyor 406, the non-ferrous residue 210 may fall off into a residue collection module 418.

The ferrous material 208, however, may be magnetically-transported in direction H (FIG. 4B) and remain magnetically attracted to the surface of the conveyor belt 414 until passing outside the range of the magnetic field of the magnet 412 below. At the discharge end 420 of the conveyor belt 414, the ferrous material 208 may fall into a metal collection module 422 communicably coupled to a ferrous material conveyor 424. The ferrous material conveyor 424 may be configured to transport the ferrous material 208 up an incline and away from the system 100 in direction I. At the discharge end 426 of the ferrous material conveyor 424, the ferrous material 208 may fall into a metal collection bin 428.

As can be appreciated, it is not necessary that the material conveyor 406 or the ferrous material conveyor 424 be arranged at an incline of any specific angular configuration. Instead, both the conveyor 406 and the ferrous material conveyor 424 may be disposed at any inclined angle, parallel to the ground, or even at a decline, depending on the location of the adjacent receptacles 418,428, respectively.

Moreover, as with prior embodiments disclosed herein, the combination material conveyor 406 and residue collection module 418 may be replaced with a dump truck for collecting the non-ferrous material 210 for shipping to another location. In at least one embodiment, for example, the non-ferrous material 210 may be further processed to remove larger rocks and eventually sold as road base material.

Likewise, the combination of the ferrous material conveyor 424 and the metal collection bin 428 may be replaced with a dump truck for directly collecting the ferrous material 208 from the crossbelt magnetic separator 410 for ease of shipping to another location. In another exemplary embodiment, the metal collection bin 428 may include the bucket of a dump truck designed to receive the ferrous material 208 and facilitate easy transportation for recycling. However, in each exemplary embodiment, the ferrous material 208 in the metal collection bin 124 may instead be repeatedly processed to ensure a cleaner product for scrap metal yards.

Referring now to FIG. 5, before processing the boiler grit 104 as described herein, it may be pre-processed using a crane 502 with an extendable high-powered magnet 504 attached thereto. As illustrated, the boiler grit 104 may be amassed into a pile, or otherwise collected into a single location, as illustrated. The pile may be located, for example, on-site at an industrial location. So as to eliminate larger non-ferrous materials 210, such as large rocks or other charred non-ferrous materials, the crane 502 may be configured to suspend the magnet 504 over the pile of boiler grit 104 and magnetically-attract the ferrous material 208 found therein. Once attracted to the magnet, the ferrous material 208 may then be deposited in an adjacent transport vehicle (not shown) for transport to a location having a system 100,400, as described herein, for further processing. The transport vehicle does not necessarily have to be a motorized vehicle, such as a truck, but may also include any means of transporting the pre-processed material to the hopper 102, 402. For example, a separate conveying system may be used to convey the material, or it could be shipped via a water vessel. As can be appreciated, pre-processing the burnt material 104 may prove advantageous in saving on transport costs and on-site processing costs, since less material is required to be transported and processed.

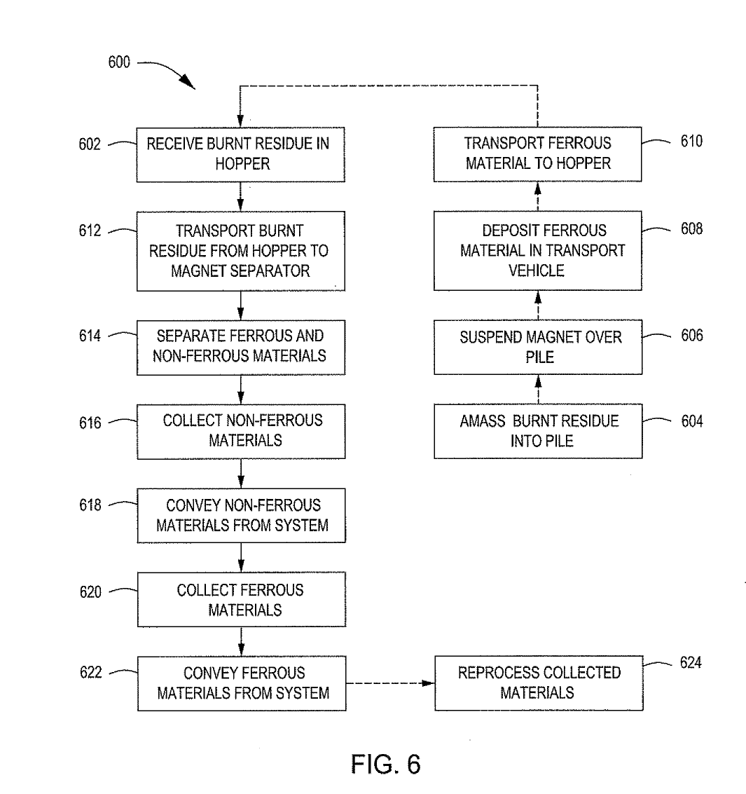

Referring now to FIG. 6, with continuing reference to FIGS. 1-5, a method 600 of removing ferrous material 208 from a boiler grit 104 having ferrous and non-ferrous materials is described. The method 600 may first include receiving the boiler grit 104 in a hopper 102,402, as at step 602. As described above, the hopper 102,402 may be a gravity or slant-style hopper, as is known in the art. The boiler grit 104 may be the result of burning pre-shredded tires for energy production in an industrial location. As a result of the burning process, the remaining ferrous material may be substantially cleaned of any rubber residue, which is generally rejected by steel mills or recycling centers.

Preceding the receipt of the boiler grit 104 by the hopper 102,402, the boiler grit 104 may optionally be pre-processed either onsite at the industrial location (not shown), or adjacent to the hopper 102,402. Part of the pre-processing may include amassing the boiler grit 104 into a localized pile, as at step 604. Instead of being in a pile, the boiler grit 104 may be simply spread out so as to more-easily locate the ferrous material 208 therein. Once in a pile or spread out, the boiler grit 104 may have a magnet suspended overhead to attract the ferrous material 208 and roughly separate it from the non-ferrous material 210, as at step 606. The ferrous material 208 may then be deposited in either an adjacent transport vehicle or other transport device, as at step 608. Once collected in a transport vehicle, the ferrous material 208 may then be transported to the hopper 102,402 for processing, as at step 610. The remaining boiler grit 104 from the pile may also be transported to the hopper 102,402 for processing.

Once received into the hopper 102,402 (step 602), the boiler grit 104, including the ferrous material 208 separated out by the magnet (step 606), may be transported away from the hopper toward a magnet separator 114,410 via a conveyor 112, as at step 612. The magnet separator 114,410 may be configured to separate the ferrous materials 208 in the boiler grit 104 from the non-ferrous materials 210, as at step 614.

The non-ferrous residue 210 may then be collected into a residue collection module 214 located adjacent to the conveyor 112, as at step 616. Once collected into the residue collection module 214, the non-ferrous materials 210 may be conveyed away from the system 100,400 via a non-ferrous material conveyor 116, as at step 618. The ferrous materials 208 are also collected in a metal collection module 124, as at step 620. The collected ferrous materials 208 may then be conveyed away from the system with a ferrous material conveyor 118, as at step 622.

Optionally, the method may include re-processing the collected ferrous material 208 or the non-ferrous material 210 by passing the material through the system 100,400 once again, as at step 624. As can be appreciated, processing the materials 208,210 multiple times may result in a substantially clean material 208,210 that may be subsequently sold or used.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A system for removing ferrous materials from furnace boiler grit, comprising:
a hopper configured to receive the boiler grit derived from burning tires, and having a vibratory feeder coupled thereto, wherein the vibratory feeder conveys the boiler grit away from the hopper;
a grating coupled to the hopper and having a plurality of slats configured to prevent the admission of large objects into the hopper, wherein the grating is disposed at an incline relative to the hopper, such that the large objects fall off the grating;
a magnetic separator having a magnet configured to attract ferrous materials in the boiler grit, thereby separating the ferrous materials from a remaining non-ferrous residue;
a residue collection module configured to collect the remaining non-ferrous residue;
a non-ferrous material conveyor configured to transport the remaining non-ferrous residue away from the system;
a metal collection module configured to collect the ferrous material; and
a ferrous material conveyor communicably coupled to the metal collection module and configured to transport the ferrous material away from the system.

2. The system of claim 1, wherein the ferrous material includes steel radials derived from the tires, the steel radials having tire residue removed during the burning process, and the tires are pre-shredded prior to burning, thereby reducing the size of the steel radials.

3. The system of claim 1, wherein the vibratory feeder is a belt-conveyor configured to transport the boiler grit towards the magnetic separator via a conveyor belt.

4. The system of claim 1, wherein the magnetic separator is a crossbelt magnetic separator having the magnet disposed between a portion of a continuous conveyor belt, whereby the magnet attracts the ferrous materials in the boiler grit onto the continuous conveyor belt.

5. The system of claim 4, wherein the magnet is a permanent magnet or an electromagnet.

6. The system of claim 4, wherein the continuous conveyor belt is a cleated belt.

7. The system of claim 4, wherein the crossbelt magnetic separator is suspended above and disposed perpendicular to, or at least at an angle with respect to, the non-ferrous material conveyor.

8. The system of claim 1, wherein the magnetic separator is a rotating drum separator having an outer drum surface that rotates independently of the magnet, wherein the magnet is disposed internally with respect to the outer drum surface and comprises a stationary, 180 degree arc.

9. A method of removing ferrous materials from boiler grit, comprising:
receiving the boiler grit in a hopper, wherein the boiler grit includes charred steel radials derived from burning tires;
transporting the boiler grit away from the hopper toward a magnetic separator via a conveyor;
separating the charred steel radials from the boiler grit using the magnetic separator, thereby leaving a non-ferrous residue;
collecting the non-ferrous residue in a residue collection module located adjacent to the conveyor;
conveying the non-ferrous residue away from the system via a non-ferrous material conveyor communicably coupled to the residue collection module;
collecting the ferrous materials in a metal collection module located adjacent to the magnetic separator; and
conveying the ferrous material away from the system with a ferrous material conveyor communicably coupled to the metal collection module.

10. The method of claim 9, wherein receiving the boiler grit in a hopper is preceded by:
amassing the boiler grit into a pile;
suspending a magnet over the pile to attract the ferrous material in the boiler grit to the magnet;
depositing the ferrous material in an adjacent transport vehicle; and
transporting the ferrous material to the hopper.

11. The method of claim 9, wherein the hopper includes a vibratory feeder coupled thereto.

12. The method of claim 9, wherein receiving the boiler grit in a hopper is preceded by the step of filtering the boiler grit with a grating having a plurality of slats, wherein the grating is configured to prevent the admission of large objects into the hopper by being disposed at an incline relative to the hopper, whereby the large objects fall off the grating

13. The method of claim 9, wherein the magnetic separator is a crossbelt magnetic separator having a magnet disposed between a portion of a continuous conveyor belt, whereby the magnet attracts the ferrous materials in the boiler grit onto the continuous conveyor belt.

14. The method of claim 9, wherein the magnet is a permanent magnet or an electromagnet.

15. The method of claim 9, wherein the magnetic separator is a rotating drum separator having an outer drum surface that rotates independently of the magnet, wherein the magnet is disposed internally with respect to the outer drum surface and comprises a stationary, 180 degree arc.

16. The method of claim 9, wherein the step of conveying the non-ferrous residue away is followed by the step of re-introducing the non-ferrous residue to the hopper for further processing and cleaning.

17. The method of claim 9, wherein the step of conveying the ferrous residue away is followed by the step of re-introducing the ferrous residue to the hopper for further processing and cleaning.

18. The method of claim 9, further comprising raking the boiler grit to a level height so that the magnetic separator continuously receives an equal amount of boiler grit, thereby avoiding clogging.

19. A system for removing ferrous materials from a boiler grit having ferrous and non-ferrous materials, comprising:
a hopper configured to receive the boiler grit, and having a vibratory feeder coupled thereto, wherein the vibratory feeder has a conveyor capable of transporting the boiler grit away from the hopper;
a magnetic separator having a magnet designed to attract the ferrous materials in the boiler grit, thereby separating the ferrous materials from the non-ferrous materials and leaving a non-ferrous residue;
a first material transportation vehicle located adjacent to the conveyor and configured to collect the non-ferrous residue for transport away from the system; and
a second material transportation vehicle located adjacent to the magnetic separator and configured to collect the ferrous material for transport away from the system.

20. The system of claim 19, wherein the boiler grit is derived from burning tires in an industrial facility and the ferrous material comprises steel radials.

21. The system of claim 19, wherein the tires are pre-shredded prior to burning, thereby cutting the size of the steel radials.
